(19) United States
(12) Patent Application Publication
(10) Pub. No.: US 2008/0280642 A1
(43) Pub. Date: Nov. 13, 2008

(54) INTELLIGENT CONTROL OF USER INTERFACE ACCORDING TO MOVEMENT

(75) Inventors: Robert Andrew Coxhill, Bolton (GB); Gary Denman, Lancaster (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/751,221

(22) Filed: May 21, 2007

Related U.S. Application Data
(60) Provisional application No. 60/917,531, filed on May 11, 2007.

(51) Int. Cl. H04M 1/00

(52) U.S. Cl. 455/556.1; 340/670

(57) ABSTRACT

A device and method of controlling a user interface of an electronic device. The method includes detecting the occurrence of an event for which a user response is desired, moving the electronic device, detecting such moving, and in response to said moving of a prescribed character, controlling the user interface of the electronic device. The controlling includes substituting an automated response for a user response.

### TECHNICAL FIELD OF THE INVENTION

The present invention relates generally to portable communication devices, and, more particularly, to a device and method for controlling a user interface of a portable communication device.

### DESCRIPTION OF THE RELATED ART

Conventional mobile phones, in addition to providing voice communication capabilities, also provide a number of non-voice related features. For example, mobile phones can be used to surf the internet, transmit and receive messages (e.g., emails and text messages), play music and videos, take and display photographs, as well as a number of other features.

Control of a mobile phone is typically effected through a plurality of buttons on the mobile phone. A user typically presses one or more buttons to navigate through a graphical user interface of the phone to place and receive calls, send and receive text messages and/or email, play music and/or video, take and display photographs, etc. Accordingly, a user typically has to actively engage the user interface in order to access the features of the mobile phone.

When an event occurs, such as an incoming call or message, etc., the user typically presses one or more buttons to accept an incoming call, view the incoming message, silence a ringer, etc. In cases when a user has missed an event and a period of time has elapsed, or when multiple events has been missed, the user may have to navigate the user interface to a missed events screen whereat the missed event will be displayed. In any case, keystrokes or other manual inputs (e.g., via a touchscreen) are typically necessary to access features of the phone though the user interface.

### SUMMARY

To improve performance and ease of use of portable communication devices, there is a need in the art for a system and method for controlling a user interface of the portable communication device without requiring active input from the user (e.g., pressing buttons). Accordingly, a device and method are provided for detecting movement of a portable electronic device and controlling a user interface of the same in response to detected movement. For example, if a phone is ringing and a user picks up the phone to view the caller ID prior to answering, such movement can be detected and the phone can be configured to silence the ringer (or reduce its volume) without active input being required from the user (other than moving the phone).

According to one aspect of the invention, a portable electronic device comprises a user interface, a transducer operable to detect motion of the electronic device, and a control circuit. The control circuit is operative to detect an occurrence of an event for which a user response is desired. The control circuit, in response to detected motion, substitutes an automated response for the desired user response to thereby control the user interface.

According to another aspect of the invention, the transducer comprises an accelerometer, a velocimeter or a signal detector.

According to another aspect of the invention, the transducer is operable to detect at least one of acceleration, position, rotation or proximity.

According to another aspect of the invention, the event includes at least one of a call, a text message, an email, an advertisement, a calendar reminder, or an alarm.

According to another aspect of the invention, the portable electronic device is operative to receive at least one of a call, a text message, an email, or an advertisement.

According to another aspect of the invention, the control circuit is operable to activate an alert when motion of the electronic device is detected after a prescribed period of time of no motion being detected.

According to another aspect of the invention, the control circuit is user configurable to control the manner in which the control circuit controls the user interface in response to detected motion of the electronic device.

According to another aspect of the invention, the control circuit is operative to substitute an automated response effective to answer an incoming call, display a message, silence a ringer, display an advertisement, or activate an alert.

According to another aspect of the invention, the user interface includes a display, and wherein the automated response initiates the display of information on the display.

According to another aspect of the invention, the user interface includes an audible alert, and wherein the automated response operates to silence the audible alert.

According to another aspect of the invention, the electronic device is a mobile phone.

According to another aspect of the invention, the electronic device is at least one of a personal audio device, a personal video device or a personal digital assistant.

According to another aspect of the invention, a method of controlling a user interface of an electronic device display comprises detecting the occurrence of an event for which a user response is desired, moving the electronic device, detecting such moving, and in response to said moving of a prescribed character, substituting an automated response for the desired user response to thereby control a user interface of the electronic device.

According to another aspect of the invention, the prescribed character includes at least one of acceleration, velocity, direction, directional change or rotation.

According to another aspect of the invention, the method further comprises enabling or disabling motion detection via a user input.

According to another aspect of the invention, the enabling or disabling motion detection via a user input includes pressing and holding a key of the mobile phone to enable motion detection.

According to another aspect of the invention, the automated response includes answering an incoming call, displaying a message, silencing a ringer, displaying an advertisement, or activating an alert.

According to another aspect of the invention, a computer program operable in electronic device, said electronic device including a user interface, comprises code to operate the electronic device to detect the character of motion of such electronic device, and code for controlling the user interface corresponding to the detected character of motion, wherein said controlling includes at least one of activating an alert or displaying information on a display of the electronic device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate;

FIGS. 4, 5 and 6 are, respectively, schematic illustrations of exemplary motion transducers providing for motion detection based on threshold, amplitude, or frequency; and

FIG. 7 is a flow chart representing an exemplary method of controlling a user interface according to movement of the mobile telephone of FIG. 1.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic device” and “electronic equipment” include portable radio communication equipment. The term “portable radio communication equipment,” which hereinafter is referred to as a “mobile radio terminal” or “mobile phone,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic device, examples of which include a media player, a gaming device, etc.

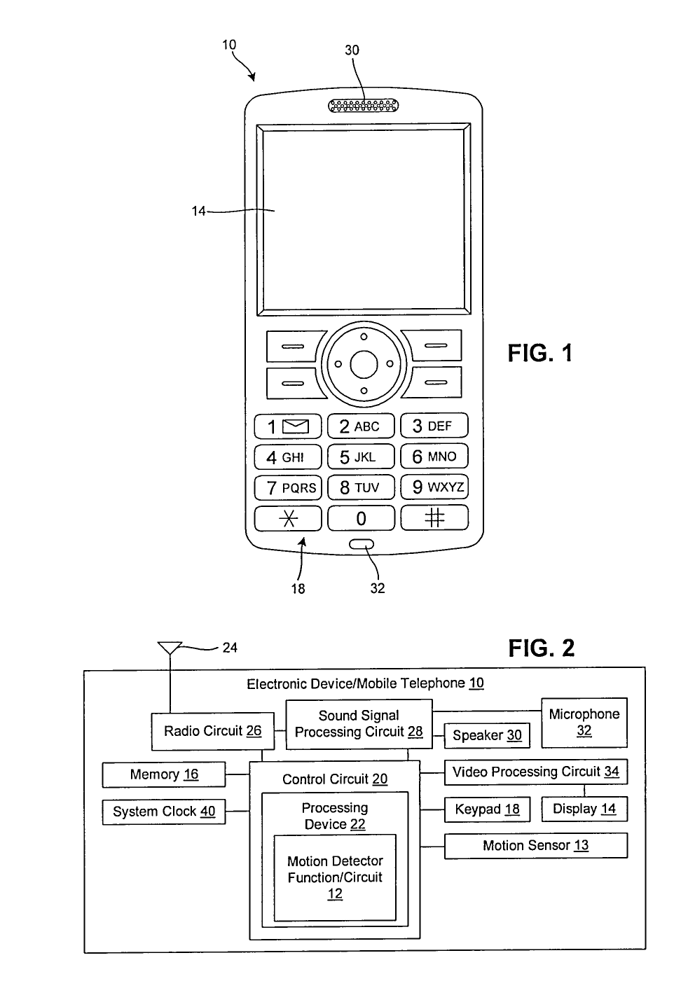

Referring initially to FIGS. 1 and 2, a portable electronic device 10 is shown. The portable electronic device of the illustrated embodiment is a mobile telephone and will be referred to as the mobile telephone or phone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile phone 10 includes a movement detector function 12 in communication with a movement detecting device (e.g., motion detector or sensor), such as motion sensor 13, for detecting movement of the electronic device 10. Additional details and operation of the motion detector function 12 and motion sensor 13 will be described in greater detail below. The movement detector function 12 may be embodied as executable code that is resident in and executed by the electronic device 10. In one embodiment, the movement detector function 12 may be a program stored on a computer or machine readable medium. The movement detector function 12 may be a stand-alone software application or form a part of a software application that carries out additional tasks related to the electronic device 10.

The movement detector function 12 and motion sensor 13 together facilitate control of the user interface without requiring active input from the user. The movement detector function 12 and motion sensor 13 can be used to detect movement of the phone 10 and in response thereto, answer and/or end calls, display messages, play videos, silence ringers or other audible alerts, etc. The movement detector function can be customized by a user to control the user interface in response to movement of the phone 10 in a desired manner. Accordingly, active input (e.g., keystrokes) is not required for a user to gain access to at least some features of the phone 10 in at least some instances.

As is typical, the mobile telephone 10 also includes a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present multimedia images, video and other graphics to the user, such as photographs, mobile television content and video associated with games. The content and multimedia can be displayed in response to a user request, or automatically in response to movement of the phone 10, as will be described.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The movement detector function 12 and the motion sensor 13 provide the mobile phone 10 with the functionality to utilize movement of the phone 10 to control various functions of the phone. As mentioned above, movement of the phone 10 can be used to silence a ringer, for example. In addition, movement of the phone 10 can be used to determine whether a user is responding to an event, for example a new text message. In this regard, when a new text message is received, the movement detector function 12 can be configured to interpret movement of the phone 10 within a prescribed period of time after receipt of the text message as the user reacting to the new text message. Accordingly, the function 12 can be configured to display the content of the text message without the user actively requesting the content of the text message to be displayed. If movement was detected prior to the receipt of the new text message, the function 12 can be configured not to take any special action, as it is likely the phone is being used by the user and, thus, the user can take action to view the text message if desired. If no movement is detected within a prescribed period of time the function 12 can be configured to activate an alert to draw the user's attention to the missed text message.

The function 12 and motion sensor 13 are also useful for displaying images and videos on the phone 10, such as from picture or video mail messages or advertisements. For example, a video mail message may be received and, upon movement of the phone being detected, automatically played by the function 12. Similarly, in the case of an advertisement, when the user picks up the phone 10, the function 12 can be configured to play an audio or video clip corresponding to the advertisement, or to start a slide show corresponding to the advertisement. Accordingly, using movement of the phone 10 to automatically initiate such features can be easier and more convenient than requiring one or more keystrokes by the user.

As is conventional, the mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10 including the motion detector function 12. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

In addition, the processing device 22 may execute code that implements the motion detector function 12. It will be apparent to a person having ordinary skill in the art of computer programming, and specifically in application programming for mobile telephones or other electronic devices, how to program a mobile telephone 10 to operate and carry out logical functions associated with the movement detector function 12. Accordingly, details as to specific programming code have been left out for the sake of brevity. Also, while the movement detector function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may include a camera 42 for taking digital pictures and/or movies. Image and/or video files corresponding to the pictures and/or movies may be stored in the memory 16.

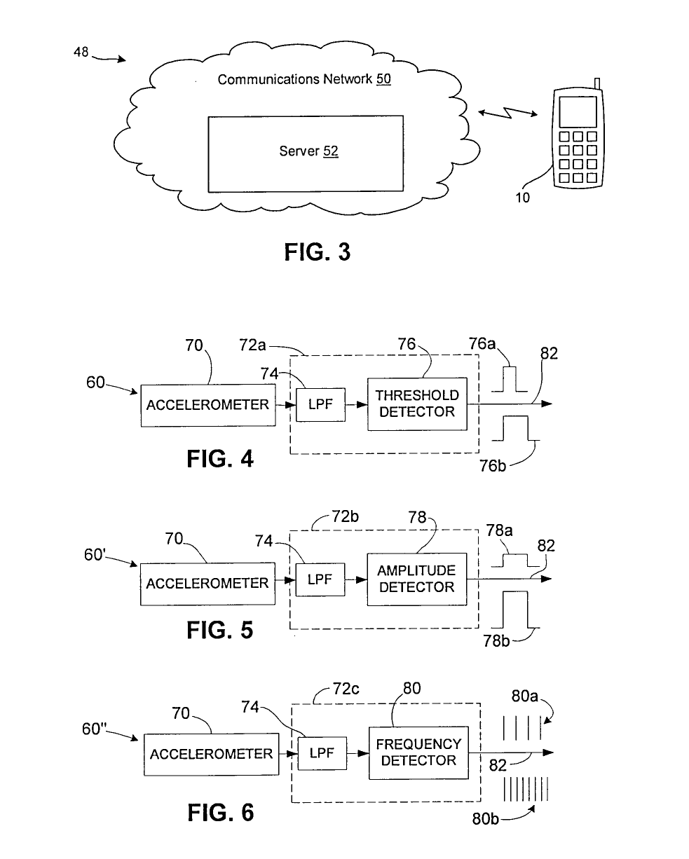

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software.

With further reference to FIGS. 4, 5 and 6, several examples of motion transducers 60, 60′ and 60″ are illustrated. The motion transducers 60, 60′ and 60″ are exemplary motion sensors that can be used in accordance with the invention for sensing motion. The motion transducer 60 shown in FIG. 4 includes an accelerometer 70. The motion transducer 60 also may include signal processing circuitry, for example, motion signal processing circuit 72, which is described below. An accelerometer 70 may provide a signal output, e.g., an electrical signal, representing acceleration of the transducer 60. The accelerometer 70 may be in the case or housing of the mobile phone 10. An accelerometer 70 is useful to produce signals representing motion occurring as a user rotates or moves the mobile phone 10 sideways, forward/reverse or up/down while holding the mobile phone 10. The transducer 60 may be a position sensor type transducer or a rotation sensing transducer, either of which may provide a signal output, e.g., an electrical signal that represents the motion of or changes in location or orientation of the mobile phone 10. Still another example of a transducer may be a proximity sensor, whereby the sensor provides a signal output representing the proximity of the mobile phone to another object.

It will be appreciated that a motion transducer may be any device, circuit or other mechanism or combination thereof that provides an indication that motion has been sensed and/or provides an indication of the character of the motion, such as, for example, acceleration, velocity, direction, directional change, rotation, or any other characterization of the motion. An example, as is mentioned above, is an accelerometer that provides an electrical output (or some other output) in response to acceleration. Another example is a velocimeter that provides an output representative of velocity. Still another example is a signal detector that responds to changes in electrical signals, radio frequency signals, or some other signals, such as amplitude or frequency or changes therein, Doppler shift, or some other discernible change that occurs due to motion.

The motion transducer 60, as is shown in respective embodiments of FIGS. 4, 5 and 6, also includes a motion signal processing circuit designated individually 72a, 72b, 72c, respectively, in FIGS. 4, 5 and 6. The accelerometer 70 produces an output indicative of motion of the mobile phone 10. This output is provided to the motion signal processing circuit 72 that processes and conditions the signal prior to being input to the control circuit 20 for use by the motion detector function 12. For example, the motion signal processing circuit 72 provides a motion signal to the control circuit 20 to indicate at least one of that motion has been detected, characteristics of that motion, e.g., duration of the motion, amplitude of the motion, frequency (e.g., changes of direction) of the motion, etc. and/or that motion has ceased. The motion signal processing circuit 72 may filter the output of the motion sensor 70 or otherwise may condition the output using known techniques such that the indication of motion or an appropriate signal to represent motion to the control circuit 20 only is provided in instances where the user decidedly moves the mobile phone 10 in a prescribed manner, e.g., in a back and forth or up and down motion or in some other prescribed manner. Such motion is referred to as intended motion. The motion signal processing circuit 72 may block from the control circuit 20 signals representing brief or casual movement of the mobile phone 10, e.g., a dead zone where slight movement of the phone, such as a result of being carried by a user while walking, bouncing in a moving car, etc., is not registered as an intended motion Therefore, the motion signal processing circuit 72 preferably requires that the output from the motion sensor 70 be maintained for at least a predetermined time, amplitude and/or frequency prior to issuing a motion indication, e.g., that intended motion has been detected, to the control circuit 20. Alternatively, the motion signal processing circuit 72 may provide inputs to the control circuit 20 and the control circuit 20 may include appropriate circuitry and/or program code to effect the desired filtering, e.g., as was just described, to avoid false indications of motion detection of a type that would result in panning and/or zooming, for example. Further, the motion signal processing circuit 72 may be enabled or disabled via function keys and/or the keypad 18.

With the above in mind, then, each of the exemplary motion signal processing circuits 72a, 72b, 72c shown in FIGS. 4, 5 and 6 includes a low pass filter 74 and either a threshold detector 76, amplitude detector 78 or frequency detector 80. In another embodiment the motion signal processing circuit may include a combination of two or more of the detectors 76, 78, 80. The low pass filter 74 removes or blocks signals representing casual motion or noise or spurious signals representing brief, unintended movement of the mobile phone 10 or casual movement of the mobile phone, such as may occur during walking or bouncing in a moving vehicle. The threshold detector 76 is designed to output an appropriate motion signal on line 82, which is coupled as an input to the control circuit 20, when motion of a relatively long duration occurs, e.g., probably not due to casual motion, noise or the like. In response to such motion signal the control circuit 20 effects control of the user interface of the mobile phone 10 in the manner described below. The threshold detected by the threshold detector 76 may be represented by pulse width of signals input thereto, and the output therefrom may be representative of such pulse width, as is represented by the relatively short and long pulse width signals 76a, 76b. The signal provided on line 82 to the control circuit 20 may be of a shape, form, duration, etc., similar to the signals 76a, 76b, may be respective high or low signals, depending on the duration of the signals 76a, 76b, may be a digital signal value of a prescribed number of data bits in length, or may be of some other character that is suitable to effect a desired operation of the control circuit 20. As several examples, the cutoff or distinguishing duration of pulse widths representing the motion detected to distinguish between intended motion and casual motion or noise may be from about a fraction of a second to up to three or four seconds; these are just exemplary and the duration or pulse width of occurrence of such motion may be more or less.

As another example of motion signal processing circuit 72b, there is illustrated in FIG. 5 a low pass filter 74 and an amplitude detector 78. The amplitude detector 78 provides an output on line 82, e.g., of a type suitable for the control circuit 20 to understand and to operate based on whether intended or prescribed motion has been detected or has not been detected. For example, casual motion or noise may produce a relatively low amplitude signal 78a as input or output from the amplitude detector; and intended or prescribed motion may produce a relatively larger amplitude signal 78b as input or output to/from the amplitude detector 78.

Still another example of motion signal processing circuit 72c is illustrated in FIG. 6 as a low pass filter 74 and a frequency detector 80. The frequency detector 80 provides an output on line 82, e.g., of a type suitable for the control circuit 20 to understand and to operate based on whether intended or prescribed motion has been detected or has not been detected. For example, casual motion or noise may produce a relatively low frequency signal 80a or respond to a relatively low frequency signal 80a, respectively, as output from or input to the amplitude detector. A relatively higher frequency signal 80b input to and/or output from the frequency detector 00 representing detection of intended motion, may be provided to the control circuit 20.

It should now be understood that the motion sensor 13 detects motion of the mobile phone 10, such as, for example, forward/reverse (z-axis), sideways (x-axis), and up/down (y-axis). The detected motion is provided to a signal conditioning circuit which can be part of the movement detector function/circuit 12, which analyzes the detected motion to determine whether the motion is intended motion or incidental motion (e.g., a slight bounce from walking or riding in a car). If the motion is determined to be intended motion, the intended motion is provided to a control circuit 20, which then operates to control the user interface, as will now be described.

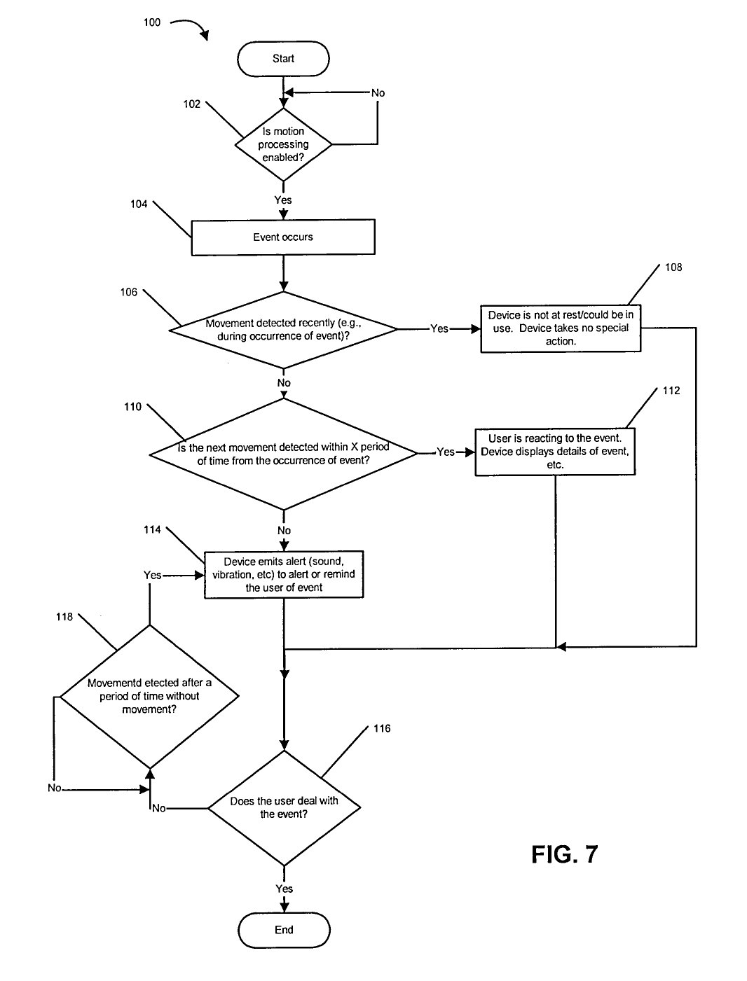

With additional reference to FIG. 7, illustrated are logical operations to implement exemplary method 100 of controlling a user interface of an electronic device. It will be appreciated that FIG. 7 is but one example of controlling a user interface in accordance with the invention. The exemplary method 100 may be carried out by executing an embodiment of the movement detector function 12 of processing circuit 20, for example. Thus, the flow chart of FIG. 7 may be thought of as depicting steps of a method carried out by the mobile telephone 10. Although FIG. 7 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Beginning at block 102, it is determined whether motion processing and control of the user interface is enabled in the mobile phone 10. If motion processing is not enabled, then the movement of the phone 10 does not result in any control of the user interface. Motion processing can be enabled, for example, by setting a parameter within the phone (e.g., via a soft menu located within the phone's setup and configuration utility) or by using one or more keys (e.g., via function keys on keypad 18) on the mobile phone 10 to enable and disable motion processing. For example, motion processing may be enabled when a specific key is depressed or key stroke is entered into the mobile phone 10, and disabled when the key is depressed again or a different keystroke is entered. If motion processing is not enabled, then the method moves back to block 102 and the process repeats. If motion processing is enabled, then the method moves to block 104.

Block 104 represents the occurrence of an event. The event can be any of a wide variety of events, such as a call or missed call, a text message, an email, an alarm, a calendar event, an advertisement, etc. The event occurrence can be accompanied by an audible or visual alert. Typically, a user response to an event is desired. In general, a user response includes a manual input by the user, such as depressing a button. For example, during an incoming call, a user typically depresses a button to receive the call. When a text message is received, a user typically displays the content of the text message by depressing a button to select the received text message. Other events, such as alarms and reminders, typically require a user to cancel or clear the event by depressing a button. In accordance with the invention, however, and as will now be described, in response to movement of the device an automated response is substituted for the desired user response thereby automating control of the user interface, at least for some functions in some instances.

Accordingly, in block 106, it is determined whether movement of the device has been detected recently. If movement has been detected recently (e.g., slightly before or during occurrence of event), the device is likely in use and, accordingly, the method moves to block 108 and no special action is taken. By way of example, if movement is detected during the occurrence of the event or within a prescribed time period prior to the occurrence of the event, a user is likely interacting with the phone (e.g., on a call, placing a text, surfing the internet, etc.) and therefore is likely to be aware of the occurrence of the event and able to take action to review the event if desired.

It will be appreciated that in some instances the device already may be in motion when an event is received even though the device is not in use, such as when the device is in a user's pocket while the user is walking, for example. Accordingly, such movement of the phone may be detected and the method may move to block 108 as set forth above even though the device is not in use. As will be described, this result can be avoided by recognizing such movement and “ambient” movement.

If no movement has been detected recently, then the method proceeds to block 110 whereat it is determined whether movement is detected within a prescribed period of time measured from the occurrence of the event in block 104. If movement is detected within the prescribed time, for example 10 seconds, then the user is likely reacting to the event and method moves to block 112 where the device displays the details of the event, such as the name and number of the missed call, the text message, the email, the advertisement, etc. Accordingly, the user need not navigate the user interface using the keypad 18 to view the event or the missed event, but rather the details of the event are automatically displayed for the user when the user moves the phone, such as by picking up the phone.

As mentioned, in some instances the device already may be in motion when an event is received, such as when the device is in a user's pocket while the user is walking, for example. Accordingly, such movement of the phone may be detected and the method may move to block 108 as set forth above. Alternatively, such motion can be identified as “ambient” movement (e.g., baseline movement) and accordingly, the method will proceed to block 110 as described. If the user then removes the device from the pocket, such movement can be detected as movement within the prescribed period of time measured from the occurrence of the event in block 104, and the method will move to block 112 as described.

Blocks 108 and 112 both lead to block 116 where it is determined whether the user has dealt with the event. Dealing with the event includes clearing the event from the screen, reading and/or responding to the event (e.g., text or email), returning a missed call, etc. If the user deals with the event, then the method ends. If the user does not deal with the event, the method moves to block 118.

At block 118, the method determines whether movement is detected after a period of no movement. If no movement is detected, the method loops at block 118 until movement is detected. Once movement is detected, the method returns to block 114 and the device emits an alert, as will be described in more detail below.

It will be appreciated that, in block 118, movement after a period without movement can occur, for example, when the event is displayed in block 112 but the user is unable to deal with the event in block 116 because the user becomes occupied with another task (e.g., operating a motor vehicle). Accordingly, while the user is occupied with the other task, no movement of the phone may be detected for a period of time. Once the user returns attention to the phone and moves it, movement then is detected after this period of time without movement, and the method proceeds to block 114.

Returning to block 110, if no movement is detected within a prescribed period of time (X) measured from the occurrence of the event in block 104, then the method moves to block 114 where an alert is activated to alert and/or remind the user of the occurrence of the event in block 102. Activation of the alert in block 114 can be used to draw the attention of the user to the phone 10. The alert can be an audiovisual alert, such as a beep, ringtone and/or flashing light. The alert can include pulsing a backlight of the display 14, for example, or activating a vibration feature of the phone 10.

The method then proceeds to block 116 where it is determined whether the user has dealt with the event. As described above, if the user deals with the event then the method ends. Otherwise the method moves to block 118 and the method loops back through blocks 114 and 116 until the user deals with the event.

It will now be appreciated that the invention improves performance and ease of use of portable electronic devices by providing a system and method for controlling a user interface of the portable electronic device in response to movement of the device. Accordingly, active input from a user (e.g., pressing buttons) is not generally required for at least some functions and features, at least some of the time.

It will be appreciated that the term “audiovisual content” broadly refers to any type of audio-based and/or video-based subject matter and may be take the form of a stored file or streaming data. Stored files may include, for example, an image file (e.g., a photograph), a music file, a ring tone, a video file, and so forth and may be stored locally by a memory of the electronic device or remotely, such as by a server. Streaming data may relate to a service that delivers audio and/or video for consumption by the electronic device and may include, for example mobile radio channels or mobile television channels. As used herein, the term “audiovisual content” expressly excludes call related operation of the electronic device 10 (e.g., generation of calling tones and/or the display of numbers or contact data on a display in connection with making or receiving a call) and expressly excludes electronic device operational functions unrelated to audio and/or video playback functions, such as menu navigation, manipulating electronic device settings, contact list management, message functions, photography functions, Internet usage functions, and so forth.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A portable electronic device, comprising:
a user interface;
a transducer operable to detect motion of the electronic device; and
a control circuit;
wherein the control circuit is operative to detect an occurrence of an event for which a user response is desired; and
wherein the control circuit, in response to detected motion, substitutes an automated response for the desired user response to thereby control the user interface.

2. The electronic device of claim 1, said transducer comprising an accelerometer, a velocimeter or a signal detector.

3. The electronic device of claim 1, said transducer operable to detect at least one of acceleration, position, rotation or proximity.

4. The electronic device of claim 1, wherein the event includes at least one of a call, a text message, an email, an advertisement, a calendar reminder, or an alarm.

5. The electronic device of claim 1, portable electronic device is operative to receive at least one of a call, a text message, an email, or an advertisement.

6. The electronic device of claim 1, wherein the control circuit is operable to activate an alert when motion of the electronic device is detected after a prescribed period of time of no motion being detected.

7. The electronic device of claim 6, wherein the control circuit is user configurable to control the manner in which the control circuit controls the user interface in response to detected motion of the electronic device.

8. The electronic device of claim 1, wherein the control circuit is operative to substitute an automated response effective to answer an incoming call, display a message, silence a ringer, display an advertisement, or activate an alert.

9. The electronic device of claim 1, wherein the user interface includes a display, and wherein the automated response initiates the display of information on the display.

10. The electronic device of claim 1, wherein the user interface includes an audible alert, and wherein the automated response operates to silence the audible alert.

11. The electronic device of claim 1, wherein said electronic device is a mobile phone.

12. The electronic device of claim 1, wherein said electronic device is at least one of a personal audio device, a personal video device or a personal digital assistant.

13. A method of controlling a user interface of an electronic device display, comprising:
detecting the occurrence of an event for which a user response is desired;
moving the electronic device;
detecting such moving; and
in response to said moving of a prescribed character, substituting an automated response for the desired user response to thereby control a user interface of the electronic device.

14. The method of claim 13, said prescribed character including at least one of acceleration, velocity, direction, directional change or rotation.

15. The method of claim 13, further comprising enabling or disabling motion detection via a user input.

16. The method of claim 15, wherein enabling or disabling motion detection via a user input includes pressing and holding a key of the mobile phone to enable motion detection.

17. The method of claim 13, wherein the automated response includes answering an incoming call, displaying a message, silencing a ringer, displaying an advertisement, or activating an alert.

18. A computer program operable in electronic device, said electronic device including a user interface, comprising:
code to operate the electronic device to detect the character of motion of such electronic device; and
code for controlling the user interface corresponding to the detected character of motion, wherein said controlling includes at least one of activating an alert or displaying information on a display of the electronic device.
